(19) United States
(12) Patent Application Publication
(10) Pub. No.: US 2011/0320359 A1
(43) Pub. Date: Dec. 29, 2011

(54) SECURE COMMUNICATION METHOD AND DEVICE BASED ON APPLICATION LAYER FOR MOBILE FINANCIAL SERVICE

(76) Inventors: Dake Li, Shanghai (CN); Jinji Zhao, Shanghai (CN); Xin Lin, Shanghai (CN); Haihui Huang, Shanghai (CN)

(21) Appl. No.: 13/139,773

(22) PCT Filed: Jun. 22, 2009
(86) PCT No.: PCT/CN09/72386

§ 371 Date: Jun. 15, 2011

Related U.S. Application Data
(60) Provisional application No. 61/201,601, filed on Dec. 12, 2008.

(51) Int. Cl. G06Q 20/00

(52) U.S. Cl. 705/71

(57) ABSTRACT

A secure communication method and device based on application layer for mobile financial service. According to the invention, the exchanged messages in the financial transaction are few, and the requirement for the processing capability of the mobile terminal is low. The invention uses the digital signature technology for information abstract based on asymmetric secret keys, and the integrity of the transaction information is guaranteed and non-repudiation requirement is met. The invention also uses digital envelop technology based on asymmetric secret keys, and the secrecy of the transaction information. The strand space theory proves that the security of the preferred embodiment of the invention can be guaranteed.

### TECHNICAL FIELD ON THE INVENTION

The invention relates to secure communications, and particularly relates to a secure communication method and device based on application layer in mobile communication.

### BACKGROUND OF THE INVENTION

Evolved from the TLS (Transport Layer Security) Version 1.0 standards, security of mobile financial services such as mobile banking systems rely mainly on the basis of transport layer security protocol, such as WTLS (Wireless Transport Layer Security) protocol. A second protocol called SET (Secure Electronic Transaction) protocol exists for similar reason. But SET fell short of its popularity due to its complexity and incompleteness to be useful for mobile applications. These mobile banking security protocols share the following common drawbacks:
Overly complicated protocols: like SET, there are excessive back and forth messages between the two parties, thus it requires high processing capability for the devices of the two parties, and make it difficult for mobile handsets or other mobile terminals with low capability to adopt this protocol;
Lack of flexibility: for example, the whole protocol stack of the secure communication protocol in transport layer needs to be completely implemented in the mobile terminals, so as to meet the need of the mobile banking service.

Per recent surveys, no application layer security protocol has ever been defined to realize secure mobile financial services. And, the applicant finds that there is a need to configure a certain secure communication mechanism in the application layer, so as to cooperate with the lower layer secure communication mechanism in the protocol stack and to better realized secure communication. This secure protocol in application layer should possess the following features:
guaranteeing the security of all transactions in the mobile financial services, i.e. secrecy, correspondence, integrity and non-repudiation of transaction communication. For example, the security protocol is supposed to have the ability to resist any malicious attacks.
message exchange should be kept at a minimum, e.g. using only two messages, request and response, to complete a transaction.

### SUMMARY OF THE INVENTION

It can be seen that a light-weight secure communication method in the application layer is required for the mobile financial services. This method should guarantee the security of transaction communications and use messages as few as possible to complete the request and response communication of the transaction.

To meet the above technical requirement, according to an embodiment in one aspect of the invention, it is provided a method, in a mobile terminal of a user, of conducting secure transaction communication with a financial server, comprising the steps of: i. creating a transaction request (req); ii. generating a digital signature of said transaction request (req) by using a private key (K_{C}⁻¹) of the user; iii. encrypting said transaction request (req) and said digital signature of said transaction request (req) by using a first secret key (k₁), and obtaining a ciphertext; iv. encrypting said first secret key (k₁) by using a public key (K_{B}) of said server; v. transmitting, to said server, the ciphertext and said encrypted first secret key (k₁).

According to an embodiment in one aspect of the invention, it is provided a method, in financial server, of conducting secure transaction communication with a mobile terminal of a user, comprising the steps of: I. receiving, from the mobile terminal, a first secret key (k₁) encrypted by a public key (K_{B}) of the server and a ciphertext, wherein said ciphertext is obtained through encrypting a transaction request (req) and a digital signature of said transaction request (req) by using said first secret key (k₁); II. decrypting said first secret key (k₁) encrypted by the public key (K_{B}) of the server, by using a private key (K_{B}⁻¹) of the server, and obtaining said first secret key (k₁); III. decrypting said ciphertext by using said first secret key (k₁) and obtaining the transaction request (req) and the digital signature of said transaction request (req); IV. determining whether the transaction request (req) matches the digital signature of said transaction request (req) by using the public key (K_{C}) of the user: conducting transactions corresponding to said transaction request (req) when matching.

According to embodiments in another aspect of the invention, it is also provided an apparatus, in mobile terminals, for conducting secure transaction communication with the financial server, and an apparatus, in financial server, for conducting secure transaction communication with the mobile terminals, corresponding to the above methods.

The embodiments of the invention propose a method for conducting mobile financial transaction in the application layer, wherein the exchanged messages are few, and the requirement for the processing capability of the mobile terminal is low. Proven by the strand space theory, the security of the preferred embodiment of the invention is guaranteed.

### BRIEF DESCRIPTION OF THE DRAWINGS

Features, aspects and advantages of the present invention will become obvious by reading the following description of non-limiting embodiments with the aid of appended drawings.

FIG. 1 shows the flowchart of the method for the mobile terminal and the financial server to conduct secure transaction communication, according to an embodiment of the invention;

FIG. 2 shows the schematic view of the strand of the user, according to an embodiment of the invention;

FIG. 3 shows the schematic view of the node n1 with digital envelop {k₁,k₂}_{K}_{_{B}}, according to an embodiment of the invention.

Wherein, same or similar reference numerals refer to the same or similar steps or means.

### EMBODIMENTS OF THE INVENTION

The embodiment elucidates the invention by using an example in which one user uses his mobile terminal MS to make mobile transactions such as transfer or payment with a financial server of the bank. The following table describes the symbols used in the embodiment:

TABLE 1

| | |
|---|---|
| C(Customer) | Identification of the handset user |
| | (such as bank account number) |
| B(Bank) | Identification of the bank |
| | (such as bank number) |
| k₁, k₂ | Random and symmetrical session key newly |
| | generated |
| K_{C}⁻¹ | private key of the handset user for |
| | signature |
| K_{C} | Public key of the handset user |
| K_{B}⁻¹ | Signature private key of the bank |
| K_{B} | Public key of the bank |
| {m}ₖ | message m encrypted by using a |
| | symmetrical secret key k |
| {m}ₖ_{^{−1}} | message m signed by using private key K⁻¹, |
| | namely encrypting message m |
| m₁, m₂ | A new message concatenated by message m₁ |
| | and m₂ |
| h(m) | Conducting Hash calculation to the |
| | message m and generating the abstract of m |
| req | Transaction request of the mobile |
| | terminal such as transfer or payment |
| res | The response result for the req by the |
| | financial server of the bank, such as |
| | transaction success, or transaction failure |
| | with reasons to the failure |

Before using the mobile bank service, the user must subscribe to this service. During the subscribing, the user will be provided with a public key K_{C} and a private key K_{C}⁻¹ corresponding to the public key, generated automatically through a certain mechanism. This user also registers to the financial server his identification (such as bank account number) and the public key K_{C}. Meanwhile, the user also obtained the public key K_{B} of the bank and stores it in the handset. Thus, the embodiment is based on the following conditions:
only the user knows his private key K_{C}⁻¹;
the user knows the public key K_{B} of the financial server of the bank;
only the financial server of bank knows its private key K_{B}⁻¹;
the financial server of bank knows the public key K_{C} of the user.

The above two pairs of public key and private key are asymmetrical. It is readily to understand that the ways of generating the asymmetrical public key and private key, as well as the handshake procedure for exchanging the public key with each other are common knowledge for those skilled in the art, thus the specification will no give unnecessary details.

When the user operates the application program such as the mobile bank client in the handset of the user to make transfer or payment transactions, at first, in step S10, the mobile terminal MS generates two random symmetrical session secret keys k₁, k₂, by for example taking a pseudo random number as the seed. These two secret keys are used for the session of the present transaction and they will expire when the present transaction ends. Randomly generating new session secret key for each transaction respectively can prevent reply attacks. It should be noted that this is a preferable embodiment. Alternatively these two secret keys can be generated and stored for a plurality of transactions within a predefined time duration, and be re-generated automatically after the predefined time duration or the plurality of transactions complete.

In step S11, the mobile terminal MS creates the transaction request req for the present transaction, according to the operation of transfer or payment from the user. This request can comprise the type of the transaction, such as transfer or payment; the currency of the transaction; the amount of the transaction; the object of the transaction, for example, the counterpart of the transaction, such as the bank account number of the counterpart or the identification of the store. The request can also comprise the identification C of the user and the identification B of the bank, for being verified by the financial server of the bank.

Then, in step S12, the mobile terminal MS generates a digital signature of the transaction request req by using the private key (K_{C}⁻¹) of the user.

In one embodiment, in step S120, the mobile terminal MS generates abstract information h(req,k₂) of a new message concatenated by transaction request (req) and the secret key k₂, according to a first abstracting rule.

After that, in step S121, the mobile terminal MS encrypts the generated abstract information by using the private key K_{C}⁻¹ of the user, and generating said digital signature {h(req,k₂)}_{K}_{_{C}}_{^{−1}} of the transaction request req.

It should be understood that the ways of generating digital signature is not limited by the above one, the application of digital signature is well known for those skilled in the art and the specification will not give unnecessary details about the other ways.

Then, in step S13, the mobile terminal MS encrypts a new message concatenated by the transaction request req and the digital signature of the transaction request req, by using the first secret key k₁, and obtains a ciphertext {req,{h(req,k₂)}_{K}_{_{C}}_{^{−1}}}ₖ_{₁}.

And, in step S14, the mobile terminal MS encrypts the secret keys k₁ and k₂ by using the public key K_{B} of the server, and obtains a digital envelop {k₁,k₂}_{K}_{_{B}}. Since only the financial server knows the private key K_{B}⁻¹ of the server, only the financial server can decrypt the digital envelop and obtain the secret keys k₁ and k₂ therein.

Then, in step S15, the mobile terminal MS transmits, to the financial server, the ciphertext {req,{h(req,k₂)}_{K}_{_{C}}_{^{−1}}}ₖ_{₁} together with the encrypted secret keys k₁ and k₂, namely transmits a message of {{req,{h(req,k₂)}_{K}_{_{C}}_{^{−1}}}ₖ_{₁},{k₁,k₂}_{K}_{_{B}}} to the financial server.

Then, in step S20, the financial server receives the message of {{req,{h(req,k₂)}_{K}_{_{C}}_{^{−1}}}ₖ_{₁},{k₁,k₂}_{K}_{_{B}}} from the mobile terminal.

After that, in step S21, the financial server decrypts {k₁,k₂}_{K}_{_{B}} by using the private key K_{B}⁻¹ of the sever, namely decrypts the secret keys k₁ and k₂ encrypted by the public key K_{B} of the server, and obtains the secret keys k₁ and k₂.

Then, in step S22, the financial server decrypts {req,{h(req,k₂)}_{K}_{_{C}}_{^{−1}}}ₖ_{₁} by using the secret key k₁, and obtains the transaction request req and the digital signature {h(req,k₂)}_{K}_{_{C}}_{^{−1}} of the transaction request req.

Then, in step S23, the financial server searches its database for the public key K_{C} of the user corresponding to the user identification, according to the user identification within the transaction request req, and loads it. The financial server further determines whether the transaction request req matches the digital signature {h(req,k₂)}_{K}_{_{C}}_{^{−1}} of the transaction request req, based on the public key K_{C} of the user: and processes the transaction request req and conducts corresponding transactions if the two match each other.

In one embodiment, in step S230, the financial server generates abstract information h′(req,k₂) for verification based on the transaction request req and the decrypted secret key k₂, based on the same abstracting rule as that used by the mobile terminal.

After that, in step S231, the financial server decrypts the digital signature {h(req,k₂)}_{K}_{_{C}}_{^{−1}} of the transaction request req by using the public key K_{C} of the user, and obtains the abstract information h(req,k₂) of the transaction request req and secret key k₂.

Then, in step S232, the financial server determines whether the abstract information h(req,k₂) of the transaction request req and secret key k₂ matches the abstract information h′(req,k₂) for verification: when matching, the financial server could determine for sure that this transaction request req was transmitted by the user, and has not been tampered, thus the non-repudiation can be guaranteed. Thus, the financial server obtains the type, currency, amount and the counterpart of the present transaction from the transaction request req, and processes this transaction, for example deducts the corresponding fund from the bank account of the user and pays this fund to the counterpart of transaction.

In one case, the transaction procedure ends once the financial server processes the transaction. In this case, the above random secret key k₂ is dispensable, namely the abstract information of the transaction request req is determined by the transaction request req itself.

In another case, after completing the processing of the transaction, the financial server further generates a transaction response and transmits it to the user based on secure transaction communication. The following will elucidate the secure communication for the transaction response according to a preferred embodiment of the invention.

In step S24, the financial server creates a transaction response res. The transaction response comprises the processing result for the transaction request req, such as transaction success, or transaction failure with reason to the failure. The transaction response res could also comprises the identification B of the bank and the identification C of the user.

In step S25, the financial server generates a digital signature of the transaction response res by using the private key K_{B}⁻¹ of the server.

In one embodiment, in step S250, the financial server generates abstract information h(res) of the transaction response res, according to a predefined abstracting rule. It should be understood that the abstracting rule used here can be either the same as or different from the abstracting rule used by the mobile terminal to generate the transaction request req.

In step S251, the financial server encrypts the abstract information h(res) of the transaction response res by using the private key K_{B}⁻¹ of the server, and generates a digital signature {h(res)}_{K}_{_{B}}_{^{−1}} of the transaction response.

It should be understood that the ways of generating digital signature is not limited by the above one, the application of digital signature is well known for those skilled in the art and the specification will not give unnecessary details about the other ways.

In step S26, the financial server encrypts the transaction response res and the digital signature {h(res)}_{K}_{_{B}}_{^{−1}} of the transaction response res by using the secret key k₂. Preferably, the financial server also encrypts the secret key k₁, and obtaining a ciphertext {res,k₁,{h(res)}_{K}_{_{B}}_{^{−1}}}ₖ_{₂}.

In step S27, the financial server transmits the ciphertext {res,k₁,{h(res)}_{K}_{_{B}}_{^{−1}}}ₖ_{₂} back to the mobile terminal MS.

In step S16, the mobile terminal MS receives the ciphertext {res,k₁,{h(res)}_{K}_{_{B}}_{^{−1}}}ₖ_{₂} from the financial server.

In step S17, the mobile terminal MS decrypts the ciphertext {res,k₁,{h(res)}_{K}_{_{B}}_{^{−1}}}ₖ_{₂} by using the session secret key k₂ generated by itself, and obtains the transaction response res, the digital signature {h(res)}_{K}_{_{B}}_{^{−1}} of the transaction response res and the secret key k₁.

In step S18, the mobile terminal searches its database for the public key K_{B} of the financial server corresponding to the bank, according to the bank identification B within the transaction response, and loads it. The mobile terminal further determines whether the transaction response res matches the digital signature {h(res)}_{K}_{_{B}}_{^{−1}} of the transaction response res, based on the public key K_{B} of the financial server: and conducts corresponding processing when matching.

In one embodiment, in step S180, the mobile terminal generates abstract information h′ (res) for verification based on the transaction response res, based on the same abstracting rule as that used by the financial server.

After that, in step S181, the mobile terminal decrypts the digital signature {h(res)}_{K}_{_{B}}_{^{−1}} of the transaction response res by using the public key K_{B} of the financial server, and obtains the abstract information h(res) of the transaction response res.

Then, in step S182, the mobile terminal determines whether the abstract information h(res) of the transaction response res matches the abstract information h′(res) for verification, and determines whether the decrypted secret key k₁ matches the secret key k₁ generated by the mobile terminal: when matching, the mobile terminal could determine for sure that this transaction response res was transmitted by the bank, and has not been tampered. Thus, the mobile terminal displays to the user that this transaction is success or failure with reason to failure, according to the transaction response res. It should be understood that the financial server transmits the ciphertext {res,{h(res)}_{K}_{_{B}}_{^{−1}}}ₖ_{₂} without the encrypted secret key k₁, then the mobile terminal only needs to determine whether the abstract information h(res) of the transaction response res matches the abstract information h′(res) for verification.

In implementation, the embodiment can be realized by SMS: when the user makes bank services by using the handset, the handset can prompt the user to input information such as account number, service code and pin code. The software in the handset executes the above method so as to generate corresponding transaction request and encrypt the transaction request as an SMS. The handset transmits the SMS to the SMS platform of the bank via the SMS gateway of the mobile operator. The SMS platform of the bank connects to the financial server of the bank, and provides the encrypted SMS to the financial server. The financial server processes the transaction request after verifying the validity of the SMS, generates a transaction response corresponding to the result of the transaction, and encrypts the transaction response. After that, the financial server transmits the encrypted transaction response to the mobile terminal of the user via the SMS platform of the bank and the SMS gateway of the mobile operator. The mobile terminal displays the result of transaction indicated in the SMS for the user after verifying the validity of the SMS.

The embodiment can also communicate with the financial server of the bank directly via an IP-based application software running in the handset.

It should be understood that the embodiments of the invention is based on the secure communication in the application layer. The mobile terminal can also deploy transport layer secure communication protocol in the transport layer according to its capability, so as to increase the security.

The digital envelope {k₁,k₂}_{K}_{_{B}} used in the embodiment is a security method using the public key of the receiver to encrypt messages. Since only the receiver knows the corresponding private key, it is the only party who can successfully decrypt the message—that is, open the envelope. The handset encrypts two new generated random keys with the public key K_{B} of the bank. Only the bank knows the corresponding private key and thus only the bank can open this envelope.

As to the calculation complexity, the embodiment relates to the mobile terminal, thus it is necessary to try the best to decrease calculation amount in the mobile terminal. In the embodiment, abstract information is obtained at first, then the signature calculation, which needs great calculation amount, is carried out on this relatively short abstract information. Thus the calculation time is decreased, the integrity of the message is guaranteed and non-repudiation requirement is met. Both of the random secret keys k₁ and k₂ in the digital envelope {k₁,k₂}_{K}_{_{B}} are generated by the handset, although the generation of one additional random secret key would increase the overhead of the handset, the bank needn't use another digital envelop to encapsulate a new secret key to the handset thus one time-consuming decryption calculation using public key is eliminated in the handset. The total calculation amount in the handset is significantly decreased. The embodiment integrates public key encryption as well as symmetrical encryption, wherein the public key encryption is for exchange the symmetrical secret key, and the symmetrical encryption is for protecting the body of the protocol message. Considering that the public key encryption is much slower than symmetrical encryption in calculation speed, the embodiment could not only obtain enough security, but also increase the speed of the protocol.

For the symmetry of the request and response, the request message has one more digital envelop than the response message, and structure, content and length of their symmetrically encrypted parts are different, thus the structure of the messages are significantly different. This asymmetric message structure is one of the effective means to resist replay attacks. The attackers can't use reflection attack, namely they can't transmit the transaction request to the handset as the response message and vice versa.

According to another embodiment of the invention, it is provided an apparatus, in mobile terminals, for conducting secure transaction communications with a financial server, comprising a device for implementing the above method. This device comprises:
a secret key generator, for generating secret keys k₁ and k₂;
a transaction requesting unit, for creating a transaction request req;
a first digital signature unit, for generating a digital signature {h(req,k₂)}_{K}_{_{C}}_{^{−1}} of the transaction request req;
a first encrypting unit, for generating the ciphertext {req,{h(req,k₂)}_{K}_{_{C}}_{^{−1}}}ₖ_{₁};
a second encrypting unit, for generating the digital envelop {k₁,k₂}_{K}_{_{B}};
a first transmitter, for transmitting a message of {{req,{h(req,k₂)}_{K}_{_{C}}_{^{−1}}}ₖ_{₁},{k₁,k₂}_{K}_{_{B}}} to the financial server;
a second receiver, for receiving a ciphertext {res,k₁,{(res)}_{K}_{_{B}}_{^{−1}}}ₖ_{₂} from the financial server;
a third decrypting unit, for decrypting the ciphertext {res,k₁,{h(res)}_{K}_{_{B}}_{^{−1}}}ₖ_{₂};
a second processing unit, for verifying whether the transaction response res matches the digital signature {h(res)}_{K}_{_{B}}_{^{−1}}: and conducting corresponding processing when matching.

According to another embodiment of the invention, it is provided an apparatus, in financial servers, for conducting secure transaction communications with a mobile terminal, comprising a device for implementing the above method. The device comprises:
a first receiver, for receiving a message of {{req,{h(req,k₂)}_{K}_{_{C}}_{^{−1}}}ₖ_{₁},{k₁,k₂}_{K}_{_{B}}};
a first decrypting unit, for decrypting {k₁,k₂}_{K}_{_{B}};
a second decrypting unit, for decrypting {req,{h(req,k₂)}_{K}_{_{C}}_{^{−1}}}ₖ_{₁};
a first processing unit, for verifying whether the transaction request req and the secret key k₂ match the digital signature {h(req,k₂)}_{K}_{_{C}}_{^{−1}}: and conducting corresponding transaction when matching;
a transacting responding unit, for generating a transaction response res;
a second digital signature unit, for generating digital signature {h(res)}_{K}_{_{B}}_{^{−1}} of the transaction response res;
a third encrypting unit, for generating a ciphertext {res,k₁,{h(res)}_{K}_{_{B}}_{^{−1}}}ₖ_{₂};
a second transmitting unit, for transmitting the ciphertext {res,k₁,{h(res)}_{K}_{_{B}}_{^{−1}}}ₖ_{₂} back to the mobile terminal MS.

The above part elucidates the preferred embodiments of the invention from the aspect of method and device. The following part will prove the security of the preferred embodiment of the invention by using the strand space.

In the theory of Strand Space model the correctness of Mobile Banking (MB) protocol can be considered in the following two aspects:
1. Correspondence means that each time a principal completes a run of the protocol as responder using a certain parameter, and then there is a unique run of the protocol with the principal as initiator using the same parameter.
2. Secrecy means that messages protected by the protocol can not be known by any unauthorized penetrator.

One thing should be pointed out is that the theory of Strand Space model defines a set of 8 types of generalized attack behaviors, currently known so far. And the following proof is based on the known set of attack behaviors.

Strand Spaces

Definition 1: An infiltrated Strand Space (Σ, P) is an MB Strand space if Σ is the union of three kinds of strands:
1. Penetrator strands p∈P.
2. Customer strands s∈Customer [B,C, k₁, k₂,req,res] with trace:

[symbol]

+{{req,{h(C,B,req,k₂)}_{K}_{_{C}}_{^{−1}}}ₖ_{₁},{k₁,k₂}_{K}_{_{B}}},−{res,k₁,{h(B,C,res)}_{K}_{_{B}}_{^{−1}}}ₖ_{₂}

[symbol]

where C,B∈T, k₁, k₂∈K, Customer [B,C, k₁, k₂,req,res] denotes the set of all strands with the trace shown. The principal associated with this Strand is handset user C.
3. Bank Strands t∈Bank [B,C, k₁, k₂, req,res] with trace:

[symbol]

−{{req,{h(C,B,req,k₂)}_{K}_{_{C}}_{^{−1}}}ₖ_{₁},{k₁,k₂}_{K}_{_{B}}},+{res,k₁,{h(B,C,res)}_{K}_{_{B}}_{^{−1}}}ₖ_{₂}

[symbol]

where C, B∈T, k₁, k₂∈K, Bank [B,C, k₁, k₂, req,res] denotes the set of all strands with the trace shown. The principal associated with this Strand is bank B.

Given any Strand s in Σ, we can uniquely classify it as a penetrator strand, a customer's strand, or a bank's Strand just by the form of its trace.

The Proof of Correspondence

Proposition 1 If:
1. Σ is an MB Strand Space, C is a bundle [4] in Σ, and s is a customer Strand in Customer [B,C, k₁, k₂, req,ans] with C−height 2.
2. K_{B}⁻¹,K_{C}⁻¹,k₁,k₂∉K_{P}.
3. k₁≠k₂, and k₁, k₂ are uniquely originating in Σ.

Then C contains an bank's Strand t∈Bank [B,C, k₁, k₂,req,res] with C−height 2.

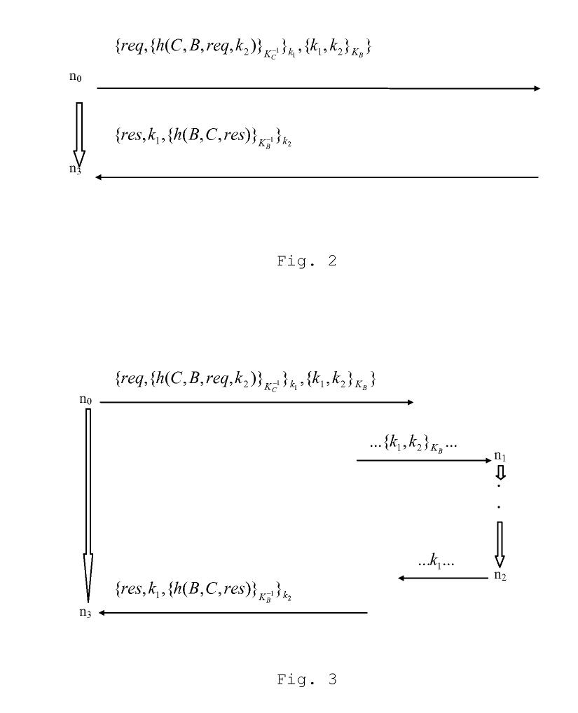

Customer' strand is depicted in FIG. 2. We will prove proposition 1 using a sequence of lemmas.

Lemma 1: The set V={n∈C:k₁⊂uns_term(n) [symbol] {k₁,k₂}_{K}_{_{B}}⊂uns_term(n)} has a ≦-minimal node n2. The node n2 is regular, and the sign of n2 is positive.

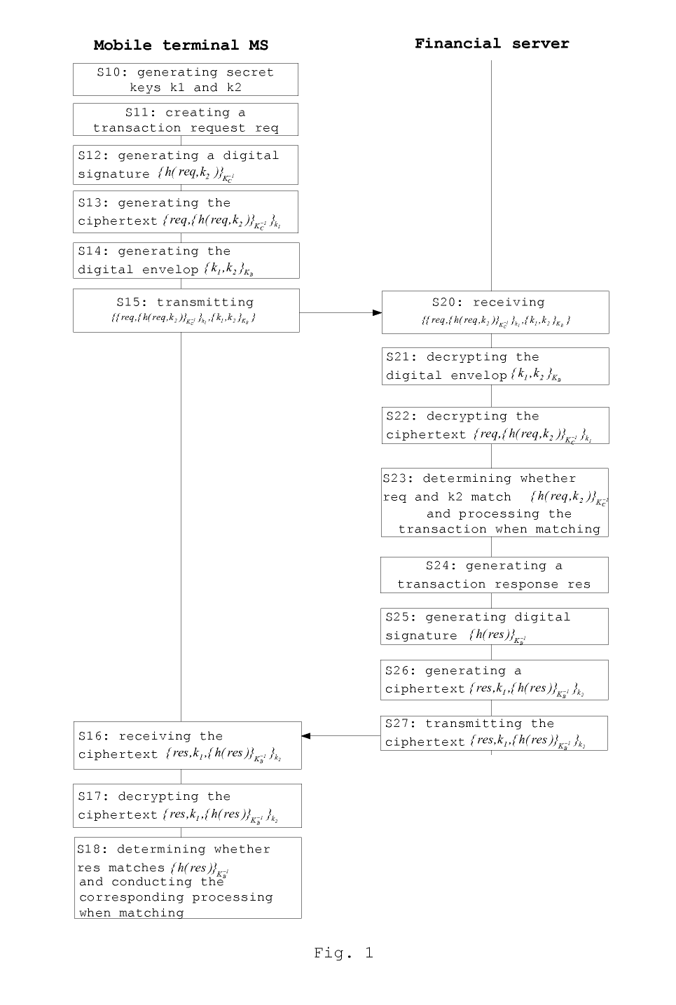

Proof. Because k₁⊂term [symbol] s,1 [symbol] =term(n₀), so k₁ originates on n0. From FIG. 1, we know n₃∈C, n₃∈V, V is non-empty. Hence V has at least one ≦-minimal element n₂. The sign of n₂ is positive.

Can n2 lie on a penetrator of strand p? There are several possibilities:

M. The trace tr(p) has the form [symbol] +t [symbol] where t∈T. But T∩K=φ, and k₁∈K, so t≠k₁. Thus, this case is invalid.

F. The trace tr(p) has the form [symbol] −g [symbol] , thus lacks any positive nodes.

T. The trace tr (p) has the form [symbol] −g, +g, +g [symbol] , so the positive nodes are not minimal occurrences.

C. The trace tr (p) has the form [symbol] −g, −h, +gh [symbol] , suppose term(n₂)=+gh. ∵k₁ is simple, ∴k₁⊂g or k₁⊂h. So the positive node is not a minimal occurrence.

E. The trace tr (p) has the form [symbol] −K,−h, +{h}_{K} [symbol] . Suppose k₁⊂{h}_{K} [symbol] {k₁,k₂}_{K}_{_{B}}⊂{h}_{K}, ∵k₁⊂{h}_{K}, k₁≠{h}_{K}∴k₁⊂h. But {k₁,k₂}⊂h, so the positive node is not minimal.

K. The trace tr (p) has the form [symbol] +k [symbol] where k∈KP. But k₁∉KP, so this case does not apply.

D. The trace tr(p) has the form [symbol] −K⁻¹, −{h}_{K}, +h [symbol] . If k₁⊂h [symbol] {k₁,k₂}_{K}_{_{B}}⊂h, according to the minimality of h, suppose {k₁,k₂}_{K}_{_{B}}⊂{h}_{K}. Hence (using the assumption of free encryption) h={k₁, k₂}, K=K_{B}. Thus there exists a node m with term(m)=K_{B}⁻¹. Since by assumption, K_{B}⁻¹∉K_{P}, we can infer that K_{B}⁻¹ originates only on a regular node. However, no valid principal originates K_{B}⁻¹.

S. The trace tr(p) has the form [symbol] −gh, +g, +h [symbol] . Without loss of generality, assume term(n₂)=g, there is a symmetrical case if term(n₂)=h. ∵k₁⊂g [symbol] {k₁,k₂}_{K}_{_{B}}⊂g, according to the minimality of g, we can suppose {k₁,k₂}_{K}_{_{B}}⊂gh. But {k₁,k₂}_{K}_{_{B}} is simple, so {k₁,k₂}_{K}_{_{B}}⊂h. Let U={m∈C:m [symbol] n₂ [symbol] gh⊂uns_term(m)}. Because term(<p,1>)=−gh, <p,1>∈U, U is non-empty. Hence U has at least one ≦-minimal element m1.

Clearly a minimal member of U cannot lie on M, F, T, K strands.

S. The trace tr (p) has the form [symbol] −g, −h, +gh [symbol] , if gh⊂term(m₁), where m₁ is a positive node on a Strand p′ of kind S, then gh⊂term(<p′,1>), <p′, 1> [symbol] m1, contradicting the minimality of m in U.

E. The trace tr (p) has the form [symbol] −K, −h, +{h}_{K} [symbol] . If gh⊂term(m₁), where m₁ is a positive node on a Strand p′ of kind E, then gh⊂term(<p′,2>), <p′,2> [symbol] m1, contradicting the minimality of m in U.

D. The trace tr(p) has the form [symbol] −K⁻¹, −{h}_{K}, +h [symbol] . If gh⊂term(m₁), where m₁ is a positive node on a Strand p′ of kind D, then gh⊂term(<p′,2>), <p′,2> [symbol] m1, contradicting the minimality of m in U.

C. The trace tr (p) has the form [symbol] −g, −h, +gh [symbol] . Suppose gh⊂term(m₁), m₁ is a positive node on a Strand p′ of kind C, then gh=term(m₁), term(<p′,1>)=g=term(n₂). Hence <p′,1> [symbol] <p′,3>=m1 [symbol] n2, contradicting the minimality of n₂ in V.

Therefore n₂ does not lie on a penetrator strand, but must lie on a regular Strand instead.

Lemma 2: A node n₁ precedes n₂, and {k₁,k₂}_{K}_{_{B}}⊂term(n₁).

Proof. As showed in FIG. 3, k₁ originates at n₀, and originates uniquely in Σ. Moreover, we have {k₁,k₂}_{K}_{_{B}}⊂term(n₀) and {k₁,k₂}_{K}_{_{B}}⊂term(n₂), so n₀≠n₂. Hence, k₁ does not originate at n₂. So there is a node n₁ preceding n₂ on the same Strand which n₂ is located in such that k₁⊂term(n₁). By the minimality property of n₂, we can infer that {k₁,k₂}_{K}_{_{B}}⊂term(n₁).

Lemma 3: The regular strand t is a bank strand contained in C, then t contains n₁ and n₂.

Proof. Node n₂ is a positive regular node and comes after a node (namely n₁) of the form {xy}ₖ. Hence t is a bank strand; if it were a customer strand, it would contain only a negative node after one of that form. However n₂ is a positive node, therefore t is a bank Strand, Thus, n₁ and n₂ are the first and second nodes of t respectively. Since the last node of t is contained in C, it must have C−height of 2.

Proposition 1 is proofed according to lemma 1 and lemma 2.

The Proof of Secrecy

We may use the same methods to show that the secret keys k₁, k₂ remains secret in the protocol.

Proposition 2: If:
1. Σ is an MB Strand Space, C is a bundle in Σ, and s is a customer Strand in Customer [B,C,k₁,k₂,req,res] with C−height 2.
2. K_{B}⁻¹,K_{C}⁻¹,k₁,k₂∉K_{P}.
3. k₁≠k₂, and k₁,k₂ are uniquely originating in Σ.

Then for all nodes m∈C such that k₁⊂term(m), either {k₁,k₂}_{K}_{_{B}}⊂term(m) or {res,k₁,{h(B,C,res)}_{K}_{_{B}}_{^{−1}}}ₖ_{₂} ⊂term(m).

Proof. Let {ans,k₁,{h(B,C,ans)}_{K}_{_{B}}_{^{−1}}}ₖ_{₂}=ν₃.

Consider the set F={n∈C:k₁⊂term(n) [symbol] {k₁,k₂}_{K}_{_{B}}⊂ term(n) [symbol] ν₃⊂term(n)}. Suppose F is non-empty, then F has at least one ≦-minimal element. We show first that such nodes are not regular. We next show that they are not penetrator nodes. Therefore F is empty, and the proposition holds.

Suppose that m∈F being minimal and a regular node, the sign of m is positive. Only n₀ in s is positive, and {k₁,k₂}_{K}_{_{B}}⊂term(n₀), so m is not in s. Moreover k₁ originates uniquely in n₀, so m can not in other regular strand s^{/}≠s. Thus m isn't a regular node.

Next proof is similar to the proof of Lemma 1. The only significant difference is that when the penetrator strand is of type D, we must consider another case. In that case, h={res,k₁,{h(B,C,res)}_{K}_{_{B}}_{^{−1}}}ₖ_{₂} and K=k₂. Thus there must be a node n with term(n)=k₂. But k₂∉K_{P}, so k₂ can only be sent from a regular node. However, no valid principal in the protocol originates k₂.

So we can draw a conclusion that F actually is empty and the occurrence of k₁ can only take the encrypted form prescribed by MB protocol. That is to say k₁ remains secret in MB protocol.

Since the secret keys k2 and k1 have equal status, Thus the proof of secrecy of k₂ is similar to that of k₁. The proof of secrecy of req is also similar to that.

Although the above description and drawings elucidate the invention, it should be noted that these elucidations are for describing and exemplifying instead of limiting; the invention is not limited by the above embodiment.

Those ordinary skilled in the art could understand and realize modifications to the disclosed embodiments, through studying the description, drawings and appended claims. The word “comprising” does not exclude the presence of elements or steps not listed in a claim or in the description. The word “a” or “an” preceding an element does not exclude the presence of a plurality of such elements. In the practice of present invention, several technical features in the claim can be embodied by one component. In the claims, any reference signs placed between parentheses shall not be construed as limiting the claim.

1. A method, in a mobile terminal of a user, of conducting secure transaction communication with a financial server, comprising the steps of:
i. creating a transaction request;
ii. generating a digital signature of said transaction request by using a private key of the user;
iii. encrypting said transaction request and said digital signature of said transaction request by using a first secret key, and obtaining a ciphertext;
iv. encrypting said first secret key by using a public key of said server; and
v. transmitting, to said server, the ciphertext and said encrypted first secret key.

2. A method according to claim 1, wherein said step ii comprises:
ii1. generating abstract information of said transaction request according to a first predefined rule; and
ii2. encrypting said abstract information by using said private key of the user and generating said digital signature of said transaction request.

3. A method according to claim 1, comprising the following step before said step iii:
generating said first secret key used for the present transaction.

4. A method according to claim 3, comprising the following step before said step ii:
generating a second secret key used for the present transaction;
said step ii1 further comprises:
generating the abstract of said transaction request together with said second secret key as said abstract information;
said step iv further comprising:
encrypting said first secret key and the second secret key by using the public key of said server;
and said step v further comprising:
transmitting, to said server, said encrypted first secret key and said second secret key.

5. A method according to claim 1, further comprising the steps of:
vi. receiving, from the server, another ciphertext, said another ciphertext being obtained by the server through encrypting a transaction response and a digital signature of said transaction response via using said second secret key;
vii. decrypting said another ciphertext by using said second secret key, and obtaining the transaction response and the digital signature of said transaction response;
viii. determining whether the transaction response matches the digital signature of said transaction response by using the public key of said server and conducting corresponding processing when matching.

6. A method according to claim 5, wherein said digital signature of said transaction response is obtained by the server through encrypting the abstract information generated from the transaction response in accordance with a second predefined rule, via using the private key of said server, and said step viii further comprises the steps of:
viii1. generating abstract information for verification based on the decrypted transaction response, according to said second predefined rule;
viii2. decrypting said digital signature of said transaction response by using the public key of the server, and obtaining abstract information of said transaction response in accordance with said second predefined rule; and
viii3. determining whether the abstract information of said transaction response in accordance with said second predefined rule matches the abstract information for verification: conducting the corresponding processing when matching.

7. A method according to claim 6, wherein said another ciphertext is obtained by the server through encrypting the transaction response, the digital signature of said transaction response and said first secret key via using said second secret key, said step vii further comprises:
decrypting said another ciphertext by using said second secret key, and obtaining the transaction response, the digital signature of said transaction response (res) and said first secret key;
said step viii3 further comprises:
determining whether the decrypted first secret key matches the first secret key generated by the mobile terminal: conducting the corresponding processing when matching.

8. A method, in a financial server, of conducting secure transaction communication with a mobile terminal of a user, comprising the steps of:
I. receiving, from the mobile terminal, a first secret key encrypted by a public key of the server and a ciphertext, wherein said ciphertext is obtained through encrypting a transaction request and a digital signature of said transaction request by using said first secret key;
II. decrypting said first secret key encrypted by the public key of the server, by using a private key of the server, and obtaining said first secret key;
III. decrypting said ciphertext by using said first secret key, and obtaining the transaction request and the digital signature of said transaction request; and
IV. determining whether the transaction request matches the digital signature of said transaction request by using the public key of the user: conducting transactions corresponding to said transaction request when matching.

9. A method according to claim 8, wherein said digital signature of said transaction request is obtained by the mobile terminal through encrypting abstract information generated from the transaction request in accordance with a first predefined rule, via using a private key of the user, and said step IV further comprises the steps of:
IV1. generating abstract information for verification based on the decrypted transaction request, according to said first predefined rule;
IV2. decrypting said digital signature of said transaction request by using the public key of the user, and obtaining abstract information of said transaction request in accordance with said first predefined rule; and
IV3. determining whether the abstract information of said transaction request in accordance with said first predefined rule matches the abstract information for verification: conducting the transaction corresponding to the transaction request when matching.

10. A method according to claim 9, wherein the digital signature of said transaction request is obtained by the mobile terminal through encrypting abstract information of both said transaction request and a second secret key in accordance with a first predefined rule, by using the private key of the user, said step I further comprises:
receiving, from the mobile terminal, said first secret key and said second secret key encrypted by the public key of the server;
said step II further comprises:
decrypting said first secret key and said second secret key encrypted by the public key of the server by using the private key of the server, and obtaining said first secret key and said second secret key;
said step IV1 comprises:
generating abstract information for verification based on the decrypted transaction request and the decrypted second secret key, according to the first predefined rule;
said step IV2 comprises:
decrypting the digital signature of said transaction request by using the public key of the user, and obtaining the abstract information of both said transaction request and the second secret key in accordance with the first predefined rule;
and said step IV3 comprises:
determining whether the abstract information of both said transaction request and said second secret key in accordance with the first predefined rule matches the abstract information for verification: conducting the transactions corresponding to said transaction request when matching.

11. A method according to claim 8, further comprising the steps of:
V. creating a transaction response;
VI. generating a digital signature of said transaction response by using the private key of the server;
VII. encrypting said transaction response and said digital signature of said transaction response, by using said second secret key, and obtaining another ciphertext; and
VIII. transmitting, to said mobile terminal, said another ciphertext.

12. A method according to claim 11, wherein said step VI further comprises the steps of:
generating abstract information of the transaction response according to a second predefined rule; and
encrypting said abstract information of the transaction response by using the private key of the server and generating said digital signature of the transaction response.

13. A method according to claim 12, wherein said step VII further comprises the step of:
encrypting said transaction response, said digital signature of the transaction response and said first secret key by using said second private key, and obtaining said another ciphertext.

14. An apparatus, in mobile terminals, for conducting secure transaction communications with a financial server, comprising:
means for creating a transaction request;
means for generating a digital signature of said transaction request by using a private key of the user;
means for encrypting said transaction request and said digital signature of said transaction request by using a first secret key, and obtaining a ciphertext;
means for encrypting said first secret key by using a public key of said server; and
means for transmitting, to said server, the ciphertext and said encrypted first secret key.

15. An apparatus, in financial servers, for conducting secure transaction communications with a mobile terminal, comprising:
means for receiving, from the mobile terminal, a first secret key encrypted by a public key of the server and a ciphertext, wherein said ciphertext is obtained through encrypting a transaction request and a digital signature of said transaction request by using said first secret key;
means for decrypting said first secret key encrypted by the public key of the server, by using a private key of the server, and obtaining said first secret key;
means for decrypting said ciphertext by using said first secret key, and obtaining the transaction request and the digital signature of said transaction request; and
means for determining whether the transaction request matches the digital signature of said transaction request by using the public key of the user: conducting transactions corresponding to said transaction request when matching.
